(19) United States
(12) Patent Application Publication
(10) Pub. No.: US 2017/0179508 A1
(43) Pub. Date: Jun. 22, 2017

(54) FUEL CELL APPARATUS

(71) Applicant: FUJI ELECTRIC CO., LTD., Kawasaki (JP)

(72) Inventors: Kuniyuki TAKAHASHI, Hino (JP); Nobuaki OHGURI, Tokyo (JP)

(73) Assignee: FUJI ELECTRIC CO., LTD., Kawasaki (JP)

(21) Appl. No.: 15/365,100

(22) Filed: Nov. 30, 2016

(30) Foreign Application Priority Data
Dec. 22, 2015 (JP) 2015-249645

(51) Int. Cl. H01M 8/04223; H01M 8/04225; H01M 8/0432; H01M 8/04701; H01M 8/04014; H01M 8/04007; H01M 8/1246; H01M 8/04302

(52) U.S. Cl. CPC H01M 8/04268; H01M 8/1246; H01M 8/04225; H01M 8/04302; H01M 8/04731; H01M 8/04022; H01M 8/04074; H01M 8/04365; H01M 8/04373; H01M 2008/1293

(57) ABSTRACT

A solid oxide fuel cell apparatus includes: a startup temperature raiser configured to mix the fuel and the air, burn a mixture of the fuel and the air using a burner to obtain combustion gas, and introduce the combustion gas to the air electrode to increase a temperature of the fuel cell stack in startup of the apparatus. The startup temperature raiser includes: a combustion cylinder through which the combustion gas passes; a cooling cylinder configured to cover an outer periphery of the combustion cylinder; and a bypass air line configured to introduce a part of the air to an air area formed between the combustion cylinder and the cooling cylinder so as to cool the combustion cylinder.

### CROSS-REFERENCE TO RELATED APPLICATION(S)

The present application claims priority to and incorporates by reference the entire contents of Japanese Patent Application No. 2015-249645 filed in Japan on Dec. 22, 2015.

### BACKGROUND OF THE INVENTION

1. Field of the Invention

The disclosure relates to a fuel cell apparatus.

2. Description of the Related Art

The operation temperature of a high-temperature type fuel cell such as a solid oxide fuel cell is about 600° C. to 1000° C. Thus, the temperature of the high-temperature type fuel cell is lowered to a room temperature once the operation is stopped, and the fuel cell needs to be heated to a high temperature again when the operation is restarted. In this case, it takes time to heat the fuel cell to a high-temperature state and, consequently, it takes time to start the fuel cell.

For this reason, in Japanese Patent Application Laid-open No. 2005-317232, a startup burner is arranged in an air introduction tube, so that fuel gas is introduced from a fuel gas introduction tube for burners and burned to heat air passing the air introduction tube, reducing time for startup.

### SUMMARY

However, when the temperature of the fuel cell stack is increased from a room temperature to a high temperature of about 600 to 1000° C. using a burner, the adjustment of combustion of fuel and air is difficult, and a dynamic range allowing stable combustion temperature adjustment is small. The combustion gas temperature is determined based on a ratio (air ratio) between a fuel amount and an air amount. For example, when the temperature of combustion gas is controlled to 300 to 650° C., and is lowered to 300° C., the air ratio becomes high, which deteriorates combustibility using a burner and causes a large amount of unburned gas and carbon monoxide. With the use of a burner, the combustion temperature is increased sharply. When the temperature of the fuel cell stack is increased sharply by combustion gas, condensation occurs easily in the fuel cell stack having delay in rise of a temperature.

In view of the foregoing, it is desirable to provide a fuel cell apparatus allowing easy temperature adjustment of combustion gas when the temperature of a fuel cell stack is increased for short time using a burner in startup of the apparatus.

According to one aspect of the present disclosure, there is provided a solid oxide fuel cell apparatus including: a fuel cell stack including a fuel electrode to which fuel is supplied and an air electrode to which air is supplied; a startup temperature raiser configured to mix the fuel and the air, burn a mixture of the fuel and the air using a burner to obtain combustion gas, and introduce the combustion gas to the air electrode to increase a temperature of the fuel cell stack in startup of the apparatus. The startup temperature raiser includes: a combustion cylinder through which the combustion gas passes; a cooling cylinder configured to cover an outer periphery of the combustion cylinder; and a bypass air line configured to introduce a part of the air to an air area formed between the combustion cylinder and the cooling cylinder so as to cool the combustion cylinder. The startup temperature raiser is configured to introduce to the air electrode by mixing the combustion gas that has been burned in the combustion cylinder and has passed through the combustion cylinder with the air introduced to the air area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a whole configuration of a fuel cell apparatus according to an embodiment of the disclosure;

FIG. 2 is a diagram illustrating a detailed configuration of a startup temperature raiser;

FIG. 3 is a section view illustrating a modification of the startup temperature raiser;

FIG. 4 is a section view along an A-A line illustrated in FIG. 3;

FIG. 5 is a flowchart illustrating the procedure of startup temperature rise control processing by a controller;

FIG. 6 is a flowchart illustrating the detailed processing procedure of temperature rise processing by the startup temperature raiser illustrated in FIG. 5;

FIG. 7 is a diagram illustrating a processing flow according to a first concrete example of the startup temperature rise control processing;

FIG. 8 is a diagram illustrating the relation among a surface temperature, a saturated air moisture amount, outside air take-in maximum moisture amount, combustion gas possible moisture amount, and a combustion gas setting temperature according to the first concrete example of the startup temperature rise control processing;

FIG. 9 is a diagram illustrating a processing flow according to a second concrete example of the startup temperature rise control processing;

FIG. 10 is a diagram illustrating the relation among a surface temperature, a saturated air moisture amount of a fuel cell stack, a saturated air moisture amount of outside air, combustion gas possible moisture amount, and a combustion gas setting temperature according to the second concrete example of the startup temperature rise control processing;

FIG. 11 is a block diagram illustrating a configuration of a first modification of the fuel cell apparatus in which a position of a heater in FIG. 1 is changed.

FIG. 12 is a block diagram illustrating a configuration of a second modification of the fuel cell apparatus in which a position of a heater in FIG. 1 is changed.

### DETAILED DESCRIPTION OF THE PREFERRED EMBODIMENTS

The following will describe an embodiment of the disclosure with reference to the enclosed drawings.

(Whole Configuration)

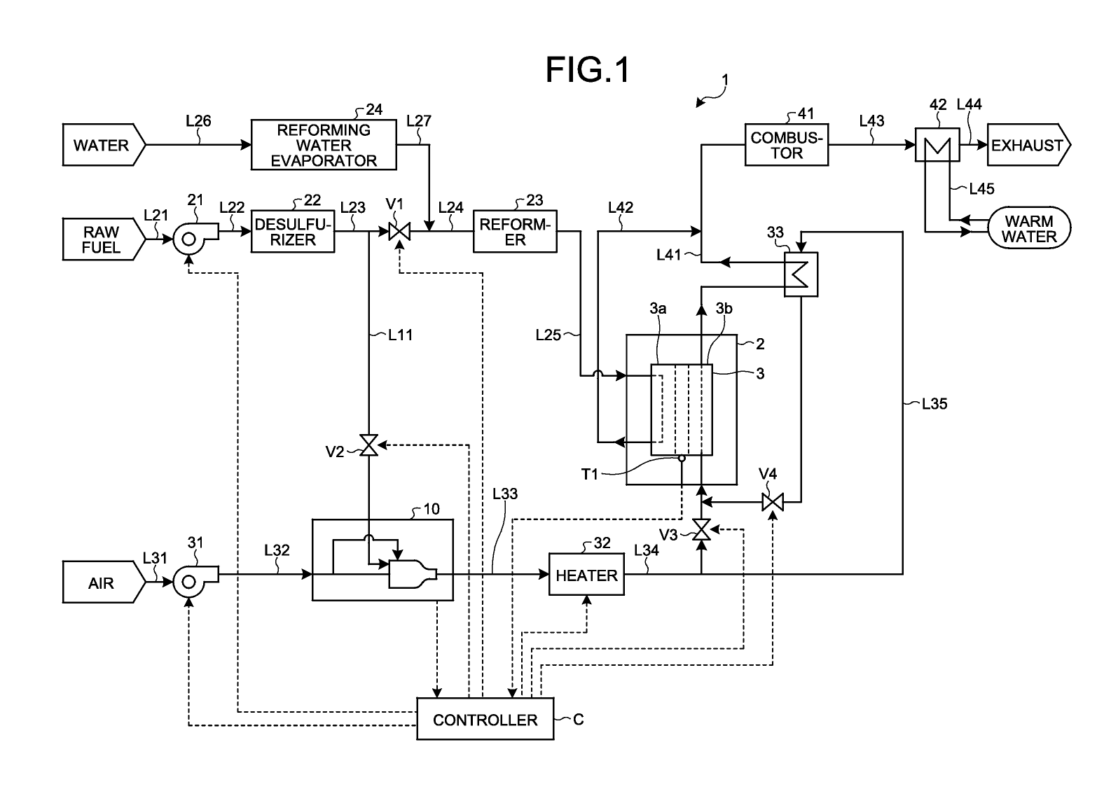

FIG. 1 is a block diagram illustrating the whole configuration of a fuel cell apparatus 1 according to an embodiment of the disclosure. The fuel cell apparatus 1 includes a fuel cell module 2. The fuel cell module 2 includes a fuel cell stack 3 provided in a heat insulating housing. The fuel cell stack 3 is a cell stack with a plurality of power generation cells that generate power by reaction of fuel introduced from a fuel supply line L25 with air introduced from an air supply line L34.

The fuel cell stack 3 may have a known configuration such as a configuration in which a plurality of cylindrical power generation cells are gathered or a configuration in which a plurality of rectangular plate shaped power generation cells are stacked, for example. The fuel cell stack 3 of the embodiment uses a solid oxide fuel cell (SOFC) in which ion conductive ceramics are interposed as an electrolyte between a fuel electrode (anode) 3a and an air electrode (cathode) 3b.

Sulfur components in raw fuel (e.g., methane gas, town gas, etc.) from a fuel supply line L21 are removed by a desulfurizer 22 connected through a fuel blower 21 and a fuel supply line L22. Furthermore, the fuel in which the sulfur components have been removed is reformed to reformed fuel containing hydrogen by a reformer 23 connected through a fuel supply line L23, a valve V1, and a fuel supply line L24, and the reformed fuel is introduced to the anode 3a via a fuel supply line L25. A reforming water evaporator 24 evaporates water introduced via a supply line L26, and introduces the evaporated water to the reformer 23 via a supply line L27. The reformer 23 generates reformed fuel in which raw fuel has been steam reformed. Note that when the cell stack has the function of the reformer 23, the reformer 23 can be omitted.

Meanwhile, air from an air supply line L31 is introduced to the cathode 3b through an air blower 31, an air supply line L32, a startup temperature raiser 10, an air supply line L33, a heater 32, and an air supply line L34 including a valve V3. Fuel is introduced to the startup temperature raiser 10 through a fuel supply line L11 diverging from the fuel supply line L23 and a valve V2. The valve V2 serving as a burner fuel controller only in startup is opened, so that the fuel and air supplied from the air supply line L32 are mixed and burned using a burner. Then, the combustion gas is drawn to the air supply line L33. The temperature of the fuel cell stack 3 increases by introducing the combustion gas to the cathode 3b. Note that the startup temperature raiser 10 is connected to the air supply lines L32, L33, and when a burner is not burning in normal operation, air introduced from the air supply line L32 is drawn as it is to the air supply line L33. In the embodiment, the air blower 31 serves as an air boosting blower that supplies air or combustion gas to the fuel cell stack 3 and an air boosting blower that supplies air to the startup temperature raiser 10. This can simplify the system and downsize the apparatus.

The heater 32 increases a temperature of air supplied from the air supply line L33. The heater 32 is used in startup of the apparatus and in normal operation.

Air offgas drawn from the cathode 3b is subjected to heat exchange by an air preheater 33, and then introduced to a combustor 41 via an offgas line L41. Meanwhile, fuel offgas drawn from the anode 3a is introduced to the combustor 41 via an offgas line L42 connected to the offgas line L41. Note that the fuel reforming reaction by the reformer 23 is an endoergic reaction, and thus a heat exchanger may be provided at the previous stage of the reformer 23 to preheat fuel using fuel offgas, for example. The air preheater 33 includes an air supply line L35 passing the air preheater 33 to preheat air in normal operation. When the air supply line L35 is used, the valve V3 is closed, and a valve V4 is open. Note that the valves V3, V4 function as switching units that switch supply of air or combustion gas to the air electrode 3b.

The combustor 41 burns the introduced fuel offgas and air offgas with a catalyst. The combustion gas is exhausted to the atmosphere through an offgas line L43, a heat exchanger 42, and an offgas line L44. The heat exchanger 42 is a heat exchanger for exhaust heat recovery, and generates warm water with an exhaust heat recovery line L45 connected thereto.

(Detailed Configuration of Startup Temperature Raiser)

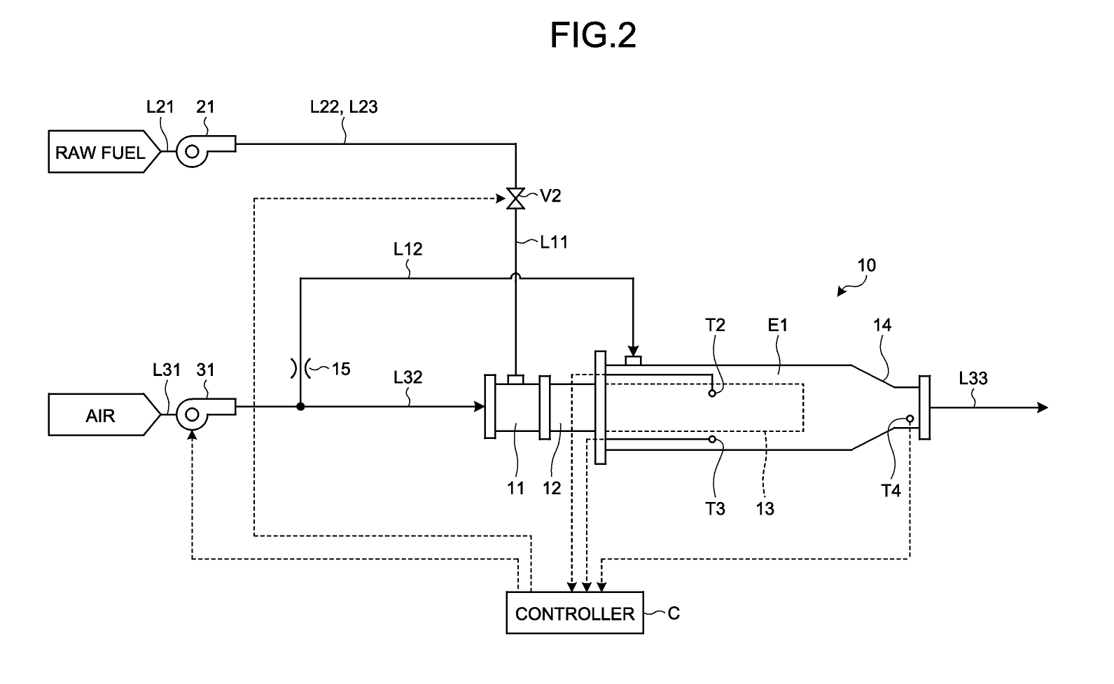

FIG. 2 is a diagram illustrating a detailed configuration of the startup temperature raiser 10. As illustrated in FIG. 2, the startup temperature raiser 10 includes a mixing unit 11, a burner unit 12, a combustion cylinder 13, a cooling cylinder 14, and a bypass air line L12. The mixing unit 11 mixes fuel introduced from the fuel supply line L11 and air introduced from the air supply line L32. The burner unit 12 starts to burn the mixed gas flowing in from the mixing unit 11 using a burner. The combustion cylinder 13 burns the mixed gas in the cylinder as a combustion area. The bypass air line L12 introduces air diverging from the air supply line L32 to a base end side (side of the burner unit 12) of the cooling cylinder 14. The cooling cylinder 14 covers the outer periphery of the combustion cylinder 13. An air area E1 is formed between the cooling cylinder 14 and the combustion cylinder 13. That is, the combustion cylinder 13 and the cooling cylinder 14 form a double tube structure. The combustion gas that has been burned in the combustion cylinder 13 and has passed through the combustion cylinder 13 is mixed with air introduced to the air area E1 and is introduced to the air electrode 3b of the fuel cell stack 3.

Air is introduced to the air area E1 via the bypass air line L12. Thus, it is possible to cool a combustion temperature in the combustion cylinder 13 and suppress an ambient temperature of the cooling cylinder 14 to be low. With the combustion cylinder 13 formed of punching metal, combustion gas and air in the air area E1 are mixed through a plurality of holes on the combustion cylinder 13 without any influence on the combustion state, further cooling the combustion gas. Therefore, when the temperature of combustion gas is controlled to 300 to 650° C., and is lowered to 300° C., for example, it can be lowered without increasing an air ratio at the combustion unit. That is, it is possible to lower the combustion gas temperature while stabilizing combustibility using a burner. As a result, the combustion gas temperature can be adjusted stably in a large dynamic range.

Note that an orifice 15 is provided on the bypass air line L12 so that air diverges at a predetermined flow ratio to the bypass air line L12 and the air supply line L32. The orifice 15 is provided to set an air flow ratio because it allows a simplified structure. An opening of the orifice 15 is determined based on a result of preliminary adjustment of combustion gas temperature. Thus, a variable flow valve may be provided instead of the orifice 15.

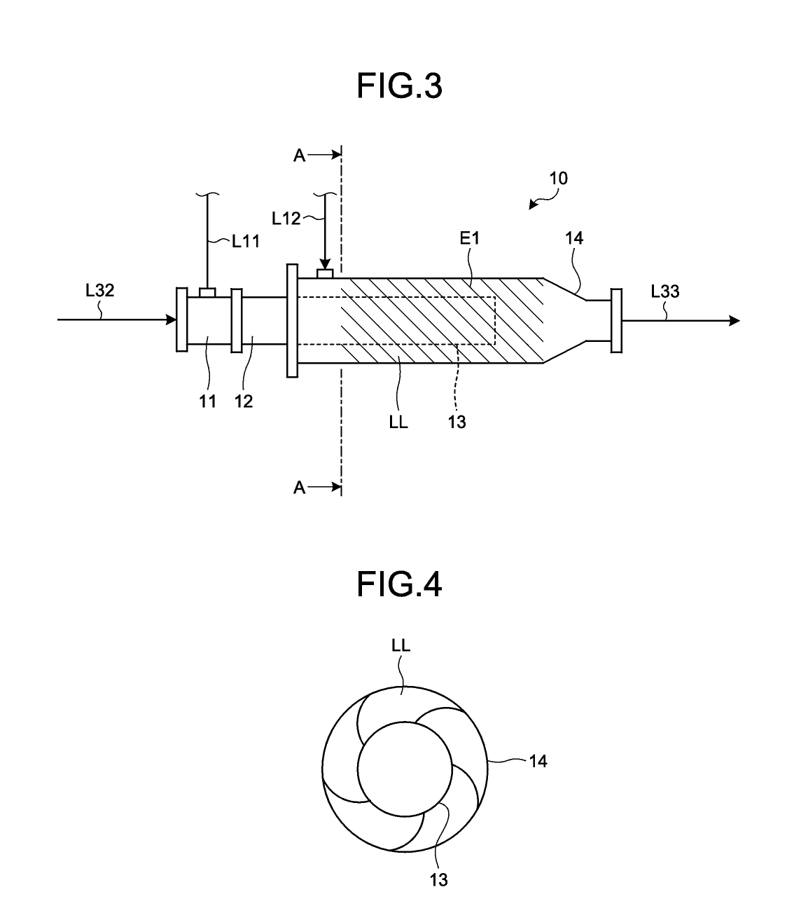

As illustrated in FIG. 3 and FIG. 4, a spiral passage LL may be formed in the air area E1 to expand a contact area of air flowing in the air area E1 with the combustion cylinder 13 and enhance the cooling effect.

Note that as illustrated in FIG. 1 and FIG. 2, a controller C obtains a surface temperature input from a surface temperature detector T1 that detects a surface temperature of the fuel cell stack 3, a combustion temperature input from a combustion temperature detector T2 that detects a combustion temperature in the combustion cylinder 13, an air temperature input from an air temperature detector T3 that detects an air temperature of the air area E1, and a combustion gas temperature input from a combustion gas temperature detector T4 arranged in the exit of the cooling cylinder 14 to detect a combustion gas temperature. The controller C controls an air supply amount by the air blower 31 based on a surface temperature, a combustion temperature, an air temperature, and a combustion gas temperature. The controller C may control a fuel supply amount by the fuel blower 21 or control both an air supply amount and a fuel supply amount. With the control of an air supply amount by the air blower 31, the structure is simpler. Moreover, the air supply amount is larger, and thus when an air supply amount is controlled, the temperature can be adjusted finely. Note that the controller C controls air temperature rise by the heater 32 based on a surface temperature. Furthermore, the controller C controls opening and closing of the valves V1 to V4. The controller C closes all of the valves V1 to V4 when operation of the apparatus is stopped. The controller C closes the valves V1, V4 and opens the valves V2, V3 in startup of the apparatus. The controller C opens the valves V1, V4 and closes the valves V2, V3 in normal operation.

(Startup Temperature Rise Control Processing)

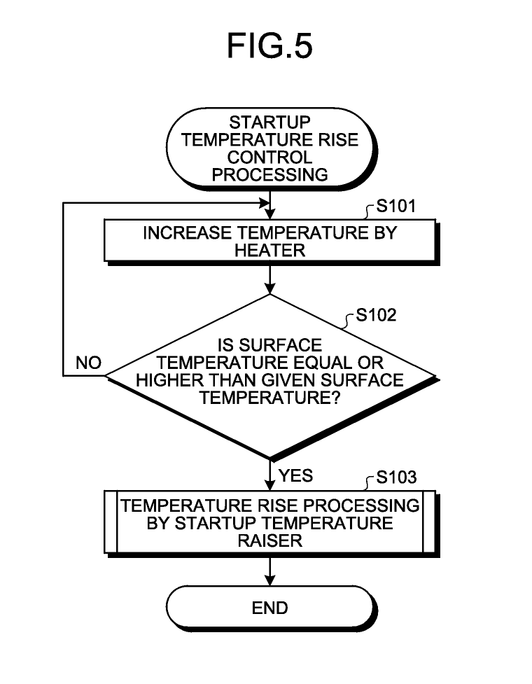

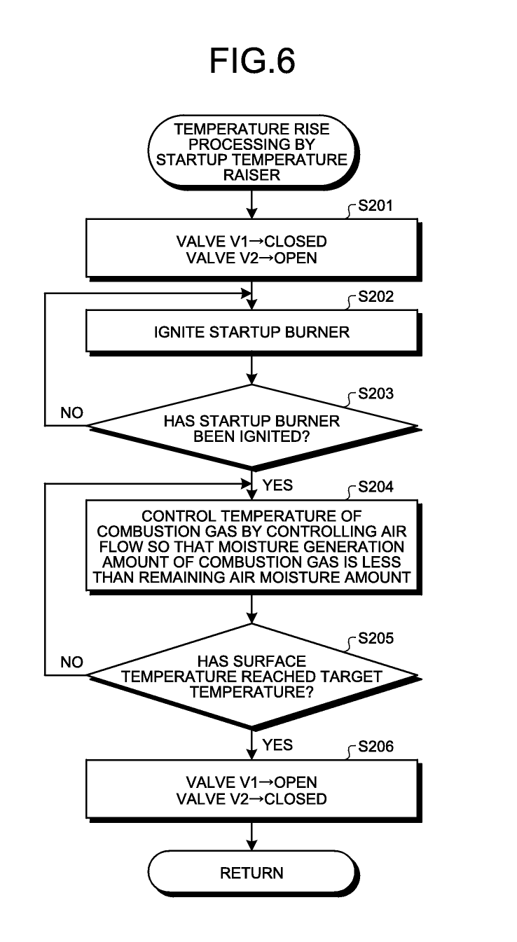

The following will describe the procedure of startup temperature rise control processing by the controller C with reference to the flowcharts illustrated in FIG. 5 and FIG. 6. First, the controller C controls all of the valves V1 to V4 to be closed when the operation of the apparatus is stopped. The controller C opens the valve V3 in startup of the apparatus, and controls the heater 32 to increase a temperature of the air to increase a temperature of the fuel cell stack 3 (Step S101).

Thereafter, the controller C determines whether the surface temperature detected by the surface temperature detector T1 has reached a predetermined surface temperature (Step S102). When the surface temperature has not reached the predetermined surface temperature (No at Step S102), the processing shifts to Step S101 so that the heater 32 continues to increase the temperature.

Meanwhile, when the surface temperature has reached the predetermined surface temperature (Yes at Step S102), the controller C controls the heater 32 to stop heating operation, controls the startup temperature raiser 10 to perform temperature rise processing (Step S103), and then finishes the processing.

As illustrated in FIG. 6, in the temperature rise processing by the startup temperature raiser 10, the valve V1 is closed and the valve V2 is opened first (Step S201). This starts fuel supply to the startup temperature raiser 10 via the fuel supply line L11. Then, the controller C ignites a startup burner (Step S202). Furthermore, the controller C determines whether the startup burner has been ignited (Step S203). Whether the startup burner is ignited can be determined by detecting a combustion temperature, for example. When the startup burner has not been ignited (No at Step S203), the processing shifts to Step S202 again to ignite the startup burner.

On the other hand, when the startup burner has been ignited (Yes at Step S203), the controller C controls a combustion gas temperature by controlling, through the air blower 31, an air flow so that a moisture generation amount of the combustion gas is less than a remaining air moisture amount obtained by subtracting an air moisture amount of air to be introduced to the startup temperature raiser 10 from a saturated air moisture amount corresponding to the surface temperature (Step S204). This increases the temperature of the fuel cell stack 3 without condensation.

Thereafter, the controller C determines whether the surface temperature has reached a target temperature, 600° C., for example (Step S205). When the surface temperature has not reached the target temperature (No at Step S205), the processing shifts to Step S204 so that the startup temperature raiser 10 continues temperature rise control processing.

On the other hand, when the surface temperature has reached the target temperature (Yes at Step S205), the valve V1 is opened and the valve V2 is closed to supply fuel to the side of the anode 3a(Step S206), while the valve V3 is closed and the valve V4 is opened to supply air to the cathode 3b through the air preheater 33. Thus, the processing shifts to normal operation. Then, the processing returns to Step S103.

(First Concrete Example of Startup Temperature Rise Control Processing)

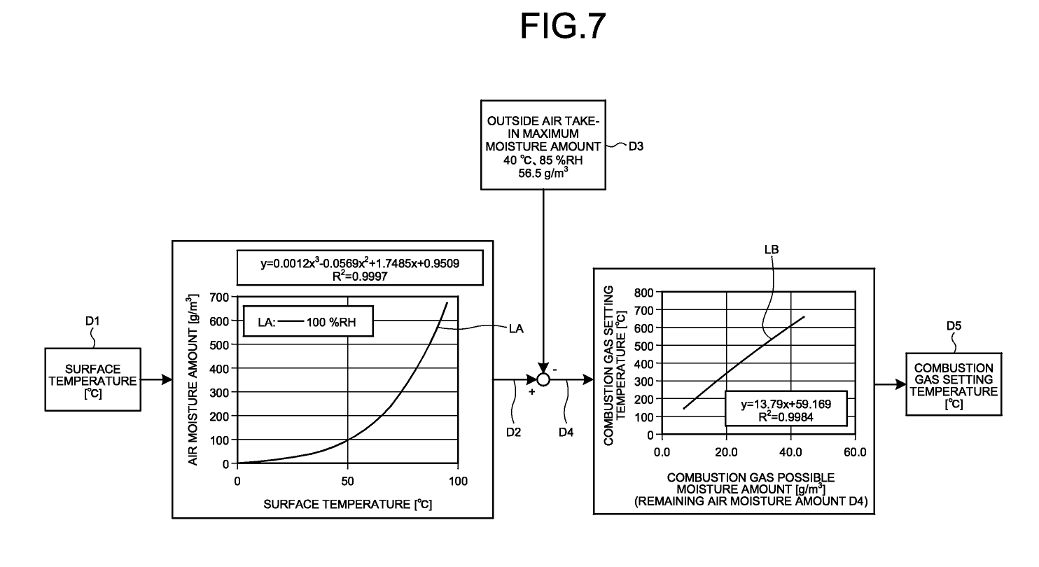

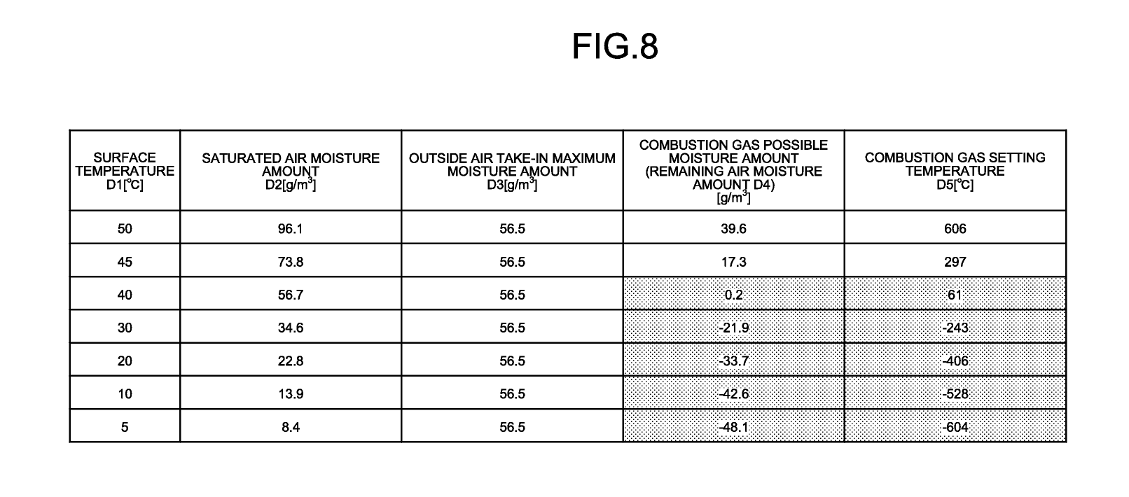

Next, the first concrete example of startup temperature rise control processing at Step S204 will be described with reference to FIG. 7 and FIG. 8. As illustrated in FIG. 7, the controller C first obtains a surface temperature D1. Note that the surface temperature D1 is a lowest surface temperature of the fuel cell stack 3. Then, the controller C calculates a saturated air moisture amount D2 corresponding to the obtained surface temperature D1, based on a curved line LA indicating the saturated air moisture amount relative to the surface temperature. Note that the curved line LA is an approximation expression, and R is a correlation coefficient.

Then, the controller C subtracts an outside air take-in maximum moisture amount D3 predetermined in the product specifications from the saturated air moisture amount D2 of the fuel cell stack 3 to calculate a remaining air moisture amount D4 of the fuel cell stack 3. The outside air take-in maximum moisture amount D3 is a predetermined maximum air moisture amount, and is a moisture amount of 56.5 [g/m³] in 40° C. and 85% RH, for example.

Thereafter, the controller C calculates a combustion gas setting temperature D5 based on a curved line LB indicating the relation of the combustion gas setting temperature (target temperature) relative to the combustion gas possible moisture amount enabling generation of a moisture amount of the remaining air moisture amount D4 in combustion gas. Note that the remaining air moisture amount D4 and the combustion gas possible moisture amount are the same value. Moreover, the curved line LB is an approximation expression, and R is a correlation coefficient.

Then, the controller C performs combustion gas temperature control in which the combustion gas temperature is controlled to be lower than the combustion gas setting temperature D5 so that the moisture generation amount of the combustion gas becomes less than the remaining air moisture amount D4. That is, the controller C performs temperature rise control of the fuel cell stack 3 while adjusting an air supply amount by controlling the air blower 31 so that the combustion gas temperature becomes lower than the combustion gas setting temperature D5.

Note that when the combustion gas setting temperature D5 is lower than 200° C., the temperature rise control by the startup temperature raiser 10 is difficult. Thus, as illustrated in FIG. 8, it is preferable that the heater 32 performs temperature rise control when the combustion gas setting temperature D5 is lower than 200° C., while it is preferable that the startup temperature raiser 10 performs temperature rise control when the combustion gas setting temperature D5 is equal to or higher than 200° C. To be more specific, the heater 32 performs the temperature rise control at least until the surface temperature D1 is 40° C.

In this case, the controller C preferably performs the temperature rise control through the startup temperature raiser 10 when the surface temperature reaches the surface temperature D1 (predetermined surface temperature at Step S102) at the combustion gas setting temperature D5 of 200° C.

Such combustion gas temperature control can prevent condensation of the fuel cell stack 3 and thus prolong the lifetime of the fuel cell stack.

(Second Concrete Example of Startup Temperature Rise Control Processing)

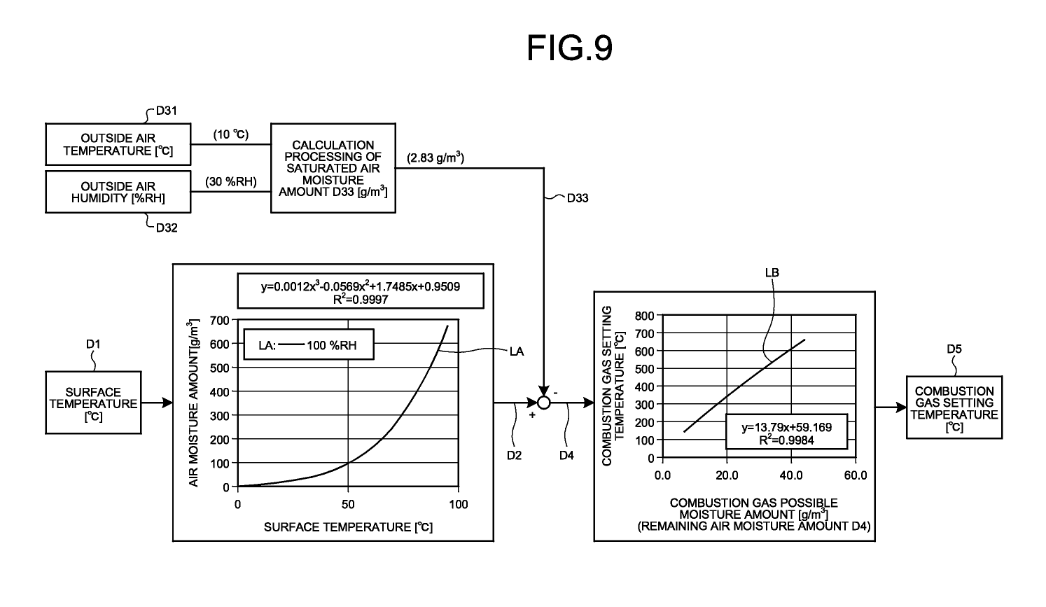

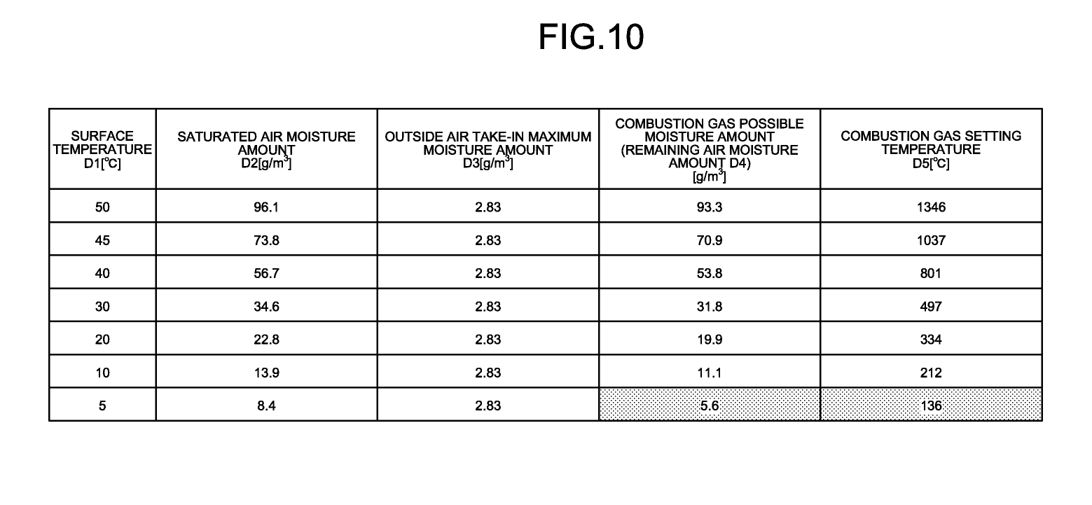

Next, the second concrete example of startup temperature rise control processing at Step S204 will be described with reference to FIG. 9 and FIG. 10. In the second concrete example, an outside air temperature detector and an outside air humidity detector that are not illustrated are provided to calculate a saturated air moisture amount D33 each time based on a detected outside air temperature D31 and outside air humidity D32, instead of the outside air take-in maximum moisture amount D3 predetermined in the product specifications.

As illustrated in FIG. 9, the controller C first obtains the surface temperature D1. Note that the surface temperature D1 is a lowest surface temperature of the fuel cell stack 3. Then, the controller C calculates the saturated air moisture amount D2 corresponding to the obtained surface temperature D1, based on the curved line LA indicating the saturated air moisture amount relative to the surface temperature. Note that the curved line LA is an approximation expression, and R is a correlation coefficient.

Then, the controller C subtracts the saturated air moisture amount D33 of air (outside air) calculated based on the outside air temperature D31 and the outside air humidity D32 from the saturated air moisture amount D2 of the fuel cell stack 3 to calculate the remaining air moisture amount D4 of the fuel cell stack 3. The saturated air moisture amount D33 is 2.83 [g/m3] when the outside air temperature D31 is 10° C. and the outside air humidity D32 is 30% RH, for example.

Thereafter, the controller C calculates the combustion gas setting temperature D5 based on the curved line LB indicating the relation of the combustion gas setting temperature (target temperature) relative to the combustion gas possible moisture amount enabling generation of a moisture amount of the remaining air moisture amount D4 in combustion gas. Note that the remaining air moisture amount D4 and the combustion gas possible moisture amount are the same value. Moreover, the curved line LB is an approximation expression, and R is a correlation coefficient.

Then, the controller C performs combustion gas temperature control in which the combustion gas temperature is controlled to be lower than the combustion gas setting temperature D5 so that the moisture generation amount of the combustion gas becomes less than the remaining air moisture amount D4. That is, the controller C performs temperature rise control of the fuel cell stack 3 while adjusting an air supply amount by controlling the air blower 31 so that the combustion gas temperature becomes lower than the combustion gas setting temperature D5.

Note that when the combustion gas setting temperature D5 is lower than 200° C., the temperature rise control by the startup temperature raiser 10 is difficult. Thus, as illustrated in FIG. 10, it is preferable that the heater 32 performs temperature rise control when the combustion gas setting temperature D5 is lower than 200° C., while it is preferable that the startup temperature raiser 10 performs the temperature rise control when the combustion gas setting temperature D5 is equal to or higher than 200° C. To be more specific, the heater 32 performs the temperature rise control when the surface temperature D1 is 5° C.

In this case, the controller C preferably performs the temperature rise control through the startup temperature raiser 10 when the surface temperature reaches the surface temperature D1 (predetermined surface temperature at Step S102) at the combustion gas setting temperature D5 of 200° C.

Such combustion gas temperature control can prevent condensation of the fuel cell stack 3 and thus prolong the lifetime of the fuel cell stack.

In the above-described embodiment, the startup temperature raiser 10 is provided on the air supply line. However, the embodiment is not limited thereto, and the startup temperature raiser 10 may be provided on the fuel supply line L11.

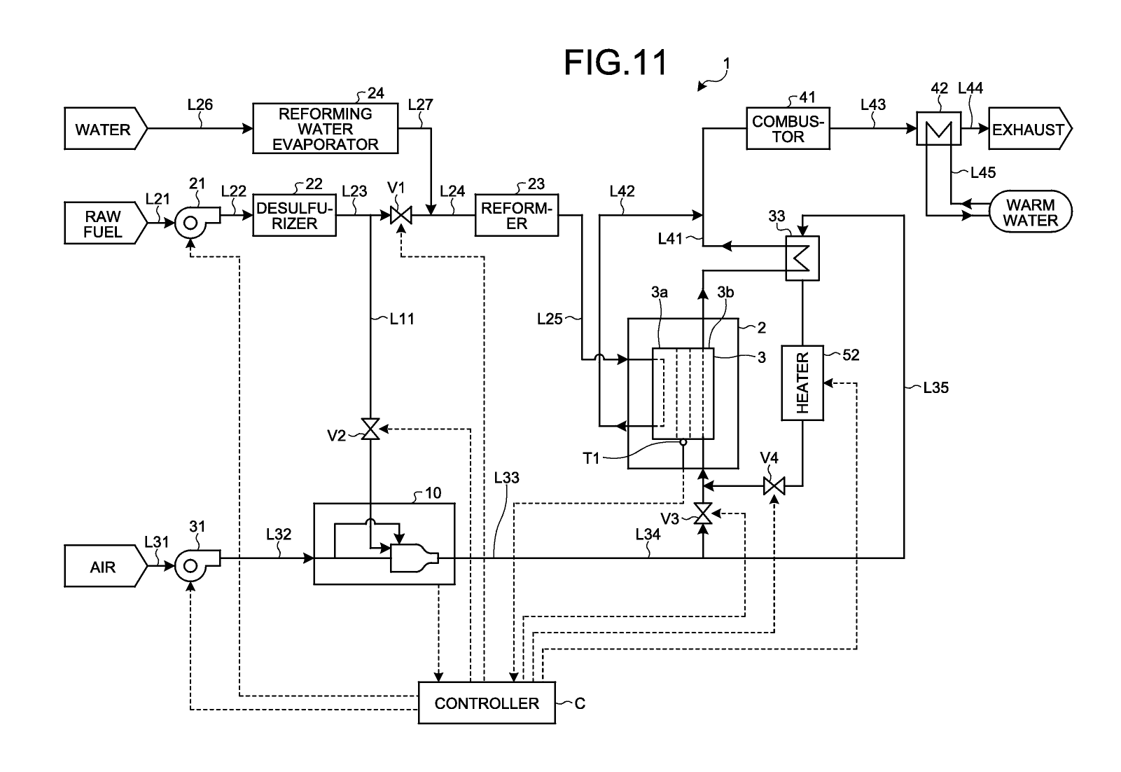

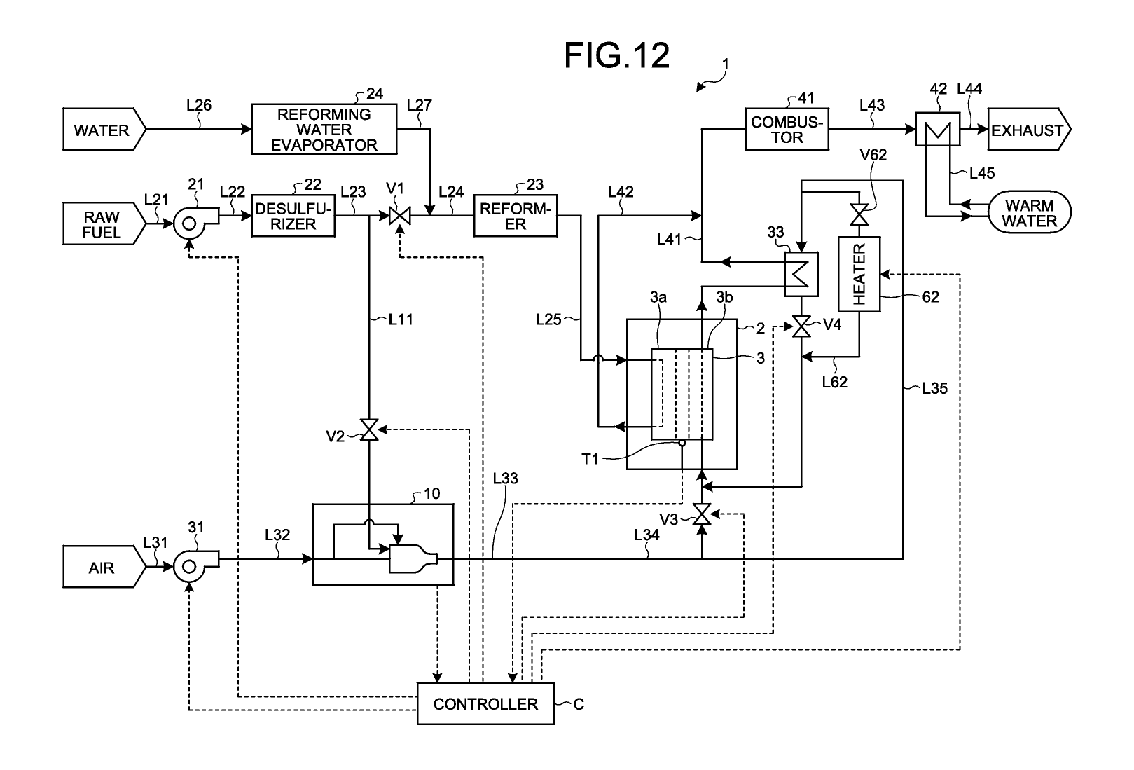

In the above-described embodiment, the heater 32 is provided at the previous stage of the air supply line L34. However, the embodiment is not limited thereto, and the heater may be provided on the air supply line L34 passing the air preheater 33, such as a heater 52 illustrated in FIG. 11. Here, when the heater 52 performs temperature rise control, the valve V3 is closed and the valve V4 is open. Furthermore, the heater (62) may be provided on a bypass line L62 bypassing the air preheater 33, such as a heater 62 illustrated in FIG. 12. Here, when the heater 62 performs temperature rise control, the valves V3, V4 are closed and a valve V62 is open. Note that when the heater 62 is not used, the valve V62 is closed. Note that combustion gas does not pass the heater 62 unlike the heaters 32, 52, and an apparatus having low heat resistance can be applied to the embodiment.

As described above, the embodiments according to the disclosure can increase a temperature of the fuel cell stack for short time, expand a temperature adjustment range of combustion gas, and facilitate temperature adjustment.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A solid oxide fuel cell apparatus comprising:
a fuel cell stack including a fuel electrode to which fuel is supplied and an air electrode to which air is supplied;
a startup temperature raiser configured to mix the fuel and the air, burn a mixture of the fuel and the air using a burner to obtain combustion gas, and introduce the combustion gas to the air electrode to increase a temperature of the fuel cell stack in startup of the apparatus, wherein
the startup temperature raiser includes:
a combustion cylinder through which the combustion gas passes;
a cooling cylinder configured to cover an outer periphery of the combustion cylinder; and
a bypass air line configured to introduce a part of the air to an air area formed between the combustion cylinder and the cooling cylinder so as to cool the combustion cylinder, and
the startup temperature raiser is configured to introduce to the air electrode by mixing the combustion gas that has been burned in the combustion cylinder and has passed through the combustion cylinder with the air introduced to the air area.

2. The solid oxide fuel cell apparatus according to claim 1, wherein the combustion cylinder includes a plurality of holes for mixing the combustion gas and the air in the air area.

3. The solid oxide fuel cell apparatus according to claim 1, wherein the air area includes a spiral passage for turning air flowing in from the bypass air line around the combustion cylinder.

4. The solid oxide fuel cell apparatus according to claim 1, wherein the bypass air line includes an orifice.

5. The solid oxide fuel cell apparatus according to claim 1, wherein the bypass air line includes a variable flow valve.

6. The solid oxide fuel cell apparatus according to claim 1, wherein the startup temperature raiser is provided on an air supply line configured to introduce the air to the air electrode.

7. The solid oxide fuel cell apparatus according to claim 1, further comprising:
an air preheater configured to preheat the air to be supplied to the air electrode;
a burner fuel controller configured to supply the fuel to the startup temperature raiser only in startup of the apparatus; and
a switching unit configured to:
allow the combustion gas from the startup temperature raiser to be supplied directly to the air electrode in startup of the apparatus; and
allow air from the startup temperature raiser to be supplied to the air electrode through the air preheater in normal operation.

8. The solid oxide fuel cell apparatus according to claim 1, further comprising:
a surface temperature detector configured to detect a surface temperature of the fuel cell stack;
a heater that is provided on an air supply line introducing the air to the air electrode; and
a controller, wherein
the controller performs no supply of the fuel to the startup temperature raiser in startup of the apparatus when a setting temperature of the combustion gas corresponding to a remaining air moisture amount that is obtained by subtracting a predetermined outside air take-in maximum moisture amount from a saturated air moisture amount corresponding to the surface temperature is equal to or lower than a predetermined temperature, and controls the heater to increase a temperature of the air to be introduced to the air electrode.

9. The solid oxide fuel cell apparatus according to claim 8, wherein the controller controls the heater to stop heating operation when the surface temperature has reached a predetermined value, and starts supply of the fuel to the startup temperature raiser.

10. The solid oxide fuel cell apparatus according to claim 1, further comprising:
a surface temperature detector configured to detect a surface temperature of the fuel cell stack; and
a controller configured to control a flow of the combustion gas based on the surface temperature so that an air moisture amount in the fuel cell stack is not saturated.

11. The solid oxide fuel cell apparatus according to claim 10, further comprising a combustion gas temperature detector configured to detect a temperature of the combustion gas, wherein
the controller controls a temperature of the combustion gas by controlling a flow of the air so that a moisture generation amount of the combustion gas is less than a remaining air moisture amount that is obtained by subtracting a predetermined maximum air moisture amount of the air to be introduced to the startup temperature raiser from a saturated air moisture amount corresponding to the surface temperature.

12. The solid oxide fuel cell apparatus according to claim 10, further comprising a combustion gas temperature detector configured to detect a temperature of the combustion gas, wherein
the controller controls a temperature of the combustion gas by controlling a flow of the air so that the moisture generation amount of the combustion gas is less than the remaining air moisture amount that is obtained by subtracting an air moisture amount in the air to be introduced to the startup temperature raiser from the saturated air moisture amount corresponding to the surface temperature.

13. The solid oxide fuel cell apparatus according to claim 11, further comprising a heater that is provided on an air supply line introducing the air to the air electrode, wherein
the controller performs no supply of the fuel to the startup temperature raiser in startup of the apparatus when a setting temperature of the combustion gas corresponding to the remaining air moisture amount is equal to or lower than a predetermined temperature, and controls the heater to increase a temperature of the air to be introduced to the air electrode.

14. The solid oxide fuel cell apparatus according to claim 12, further comprising a heater that is provided on an air supply line introducing the air to the air electrode, wherein
the controller performs no supply of the fuel to the startup temperature raiser in startup of the apparatus when a setting temperature of the combustion gas corresponding to the remaining air moisture amount is equal to or lower than a predetermined temperature, and controls the heater to increase a temperature of the air to be introduced to the air electrode.

15. The solid oxide fuel cell apparatus according to claim 13, wherein the controller controls the heater to stop heating operation when the surface temperature corresponding to the remaining air moisture amount has reached a predetermined value, and starts supply of the fuel to the startup temperature raiser.

16. The solid oxide fuel cell apparatus according to claim 14, wherein the controller controls the heater to stop heating operation when the surface temperature corresponding to the remaining air moisture amount has reached a predetermined value, and starts supply of the fuel to the startup temperature raiser.
